(19) United States
(12) Patent Application Publication
(10) Pub. No.: US 2009/0072539 A1
(43) Pub. Date: Mar. 19, 2009

(54) DEVICE, SYSTEM, AND METHOD FOR HARNESSING FLUID ENERGY

(76) Inventors: Robert H. Turner, Reno, NV (US); Cahit A. Evrensel, Reno, NV (US)

Correspondence Address: Ryan A. Heck, Ph.D.;Patent Counsel and Associate Director, UNR/DRI Technology Transfer Office, Mail Stop 321, Ross Hall 218, Reno, NV, 89557, US

(21) Appl. No.: 12/211,683

(22) Filed: Sep. 16, 2008

Related U.S. Application Data
(60) Provisional application No. 60/994,200, filed on Sep. 17, 2007.

(51) Int. Cl. F03B 13/22

(52) U.S. Cl. 290/53

(57) ABSTRACT

In various embodiments, the present disclosure provides a method, device, and system for generating energy from fluid motion, such as from sea waves. In a specific example, the disclosure provides a device having a submersible housing having an inlet and an outlet. When submerged, the inlet faces toward the direction of fluid propagation such that the fluid is incident on the inlet. The outlet includes a one-way check valve to pass water flowing through the housing from the inlet. The housing further includes a turbine positioned between the inlet and outlet such that water may flow from the inlet, past the turbine, and through the outlet. The turbine is coupled to an electrical generator. In some examples, the fluid has a wavelength λ and the region of the housing between the inlet and outlet has an axial length of λ/2. In further embodiments, the device includes a plurality of inlets and outlets located at different axial positions on the housing. The inlets and outlets are arranged in sets; each set having an axial length corresponding to half the wavelength of a fluid wave.

### CROSS REFERENCE TO RELATED APPLICATION

This application claims the benefit of, and incorporates by reference, U.S. Provisional Patent Application No. 60/994,200, filed Sep. 17, 2007.

### FIELD

Generally, this disclosure is directed to a device, system, and method for converting fluid energy, such as from sea waves, into another form of energy, such as electrical energy. Various embodiments of the device have relatively low numbers of moving parts, and are situated substantially under the sea surface during operation. The device exploits pressure changes along a horizontal line below the sea surface due to moving waves to generate flow in a tube and to convert this flow into usable energy.

### BACKGROUND

Electrical power generated from sea-waves can be an excellent complement to other renewable sources of power, such as solar, wind, etc. In fact, ocean waves are a concentrated tertiary form of solar energy: solar heating produces wind, which produces waves. Sea-waves are generally available 24 hours/day, every day. Also, sea-waves generally are more powerful in winter than in summer. For some countries and regions around the world, sea-waves have tremendous potential to provide clean renewable energy to a sustainable society.

Energy conversion from sea-waves has been seriously analyzed for over a century. Stahl, “The Utilization of the Power of Ocean Waves”, Transactions of ASME, Vol. 13, 1892. The following reviews discuss previous efforts: Shaw, Wave Energy˜A Design Challenge, Ellis Harwood Pub., 1982; Seymour (Ed.), Ocean Energy Recovery˜The State of the Art; ASCE Pub., N.Y., 1992; Salter, “World Progress in Wave Energy—1988”, International Journal of Ambient Energy, Vol. 10, January, 1989, McCormick, Ocean Wave Energy Conversion; John Wiley & Sons, N.Y., 1981; and Duckers (Ed.), “Wave Energy Devices”, Solar Energy Society˜Conference Proceedings (C 57), London, March, 1990. New system concepts are still being introduced. Von Jouanne, “Harvesting the Waves”, Mechanical Engineering Journal, Vol. 128, No. 12, ASME, December 2006. Also, wave dynamics are understood. See, e.g., Sorenson, Basic Wave Mechanics for Coastal and Ocean Engineers, John Wiley & sons, N.Y., 1993; and Wiegel, Oceanographical Engineering, Prentice-Hall Inc., N.J., 1964.

In view of the constant motion of the sea and of the large forces that underlie the motion (and in view of the fact that sea motion represents a “free” source of energy), it is no wonder that thought has been given to finding practical ways in which to harvest the energy of that motion. But, to obtain power from sea-waves, many practical considerations must be addressed, including prevailing sea conditions expected in the intended location of the devices, reliability of the devices, resistance to damage caused by sea-water corrosion and the like, resistance to damage caused by difficult weather conditions, ease of maintenance, etc. Salt-water environments are highly corrosive and present constant challenges from fouling. Also, devices situated in the sea are subject to constant buffeting by winds and moving sea water. The larger the device, the more pronounced these effects and other forces on the device can be. Also, sea-borne devices typically need repair or servicing just at the moment when conditions are worst, such as during a storm.

In view of the foregoing, there is a need for more efficacious and more reliable devices for producing power from the motion of sea-waves.

### SUMMARY

The foregoing need is addressed in the instant disclosure directed to several aspects such as devices and methods. The subject devices and methods, in contrast to conventional devices and methods, do not rely on the motion of mechanical components, except one-way valves and turbines, to generate energy. Hence, the subject devices, for example, are simpler and more reliable than conventional devices. Also, the subject devices are normally situated entirely under water and hence are protected from potentially damaging effects of weather.

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. Any particular embodiment need not provide all features noted above, nor solve all problems or address all issues in the prior art noted above.

### BRIEF DESCRIPTION OF THE DRAWINGS

FIG. 1 is a schematic drawing of a device according to a first representative embodiment.

FIG. 2 provides plots of sinusoidal pressure profiles resulting from progression of a sea-wave through the device of FIG. 1. The pressure profiles are shown at times t=0, T/4, T/2, 3T/4, and T, wherein T is the period of the subject sea-wave.

FIG. 3 is a schematic drawing of a device according to a second representative embodiment.

FIG. 4 provides plots of sinusoidal pressure profiles resulting from progression of a sea-wave through the device of FIG. 3. The pressure profiles are shown at times t=0, T/4, T/2, 3T/4, and T, wherein T is the period of the subject sea-wave.

FIG. 5 is a schematic drawing of a device according to a third representative embodiment.

FIG. 6(A) is a schematic drawing of a device from which the pressure profile of FIG. 6(B) was obtained.

FIG. 6(B) is a plot of a profile of pressure versus distance for the device of FIG. 6(A).

FIG. 7(A) is a table of data concerning the ratio of power to maximum power, corresponding to various values of R=Hₚ/H.

FIG. 7(B) is a plot of the data of FIG. 7(A).

FIG. 8 is a plot of water velocity (Vₙ) versus time (tₙ) as discussed in Example 1.

FIG. 9 is a plot of power (Pₙ) versus time (tₙ) as discussed in Example 1.

### DETAILED DESCRIPTION

Unless otherwise explained, all technical and scientific terms used herein have the same meaning as commonly understood by one of ordinary skill in the art to which this disclosure belongs. In case of conflict, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together. All numerical ranges given herein include all values, including end points (unless specifically excluded) and any and all intermediate ranges between the endpoints.

Although methods and materials similar or equivalent to those described herein can be used in the practice or testing of the present disclosure, suitable methods and materials are described herein. The disclosed materials, methods, and examples are illustrative only and not intended to be limiting.

By “sea-wave” is meant a wave in any body of water in which systems as disclosed herein may be used. Since the bodies of water are not limited to oceans or seas, and can include lakes, rivers, and the like, a “sea-wav”” is not limited to a wave in an ocean or sea.

In the following description, terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

In certain embodiments of generating systems, a tube-like housing has an inlet end and an outlet end and has a turbine (or analogous rotational member) located between the ends, such as a location intermediate the ends. The housing defines one or more sets of openings (each set including a respective inlet and a respective outlet, wherein the inlet is on one side of the turbine and the outlet is on the other side of the turbine). For example, in one set, the inlet can be located on the upstream end of the housing and the outlet can be located on the downstream end of the housing, with the turbine in the housing being located between the inlet and outlet. The set or other set(s) of openings can be located along the length (L) of the housing. In a body of water in which sea-waves are propagating, the generating system is submerged and typically anchored in a manner allowing it to orient itself with the upstream end facing toward a propagating wave. I.e., the inlet(s) are oriented upstream, toward advancing waves, and the outlet(s) are oriented downstream. Normally, the housing self-orients in this manner.

In certain embodiments, openings are separated from each other by approximately half the wavelength of a sea-wave (i.e., λ/2 where λ is the wavelength of the wave). Outlets and inlets have respective one-way valves (also called “check-valves”). More specifically, each of the outlet(s) desirably has a respective valve, and one or more of the inlets may have a valve. Each valve is “one-way” in that it opens to permit flow of water through the housing in the normal wave-propagation direction, and closes to prevent reverse-flow of water through the housing. The valves desirably are passive and operate automatically by differential pressure. For example, a higher pressure on the upstream side of the valve, relative to the downstream side of the valve, will cause the valve to open; a lower pressure on the upstream side relative to the downstream side will cause the valve to close; and the valve will tend to be closed if substantially equal pressures are on both sides of the valve. If an inlet includes a valve, the valve opens to admit forward flow of water accompanying the wave into the housing whenever the pressure at the valve is greater outside than inside. The corresponding outlet valve opens to allow water flow urged by the propagating wave to exit the housing downstream of the turbine.

The generating system desirably is submerged just below the low-tide surface of the body of water. In a typical sea-wave (e.g., of a sinusoidal character), substantially half the wave (the “wave-crest” portion) provides net elevated pressures compared to average for the wave, and substantially the other half of the wave (“wave-trough” portion) provides net reduced pressures relative to average for the wave. As the wave propagates to the housing, the wave encounters the upstream end first because the upstream end is facing the oncoming wave.

In a set of openings, the outlet is located downstream of the inlet so that, as the inlet encounters an incident wave-crest portion, the outlet is experiencing the wave-trough portion of the preceding wave completing its propagation through the housing. This situation produces a substantial pressure drop, from the inlet to the outlet of the set, across the turbine for urging forward water flow through the turbine. In the first and second embodiments described below, the best performance in this regard is typically achieved whenever the inlet and outlet of the set are separated from each other by λ/2, which yields the greatest pressure drop in the housing from upstream to downstream of the turbine. As water flows forward through the turbine, the turbine rotates and causes the generator to produce power. This situation also causes the inlet valve (if present) and the outlet valve to be open, which allows simultaneous forced entry of water of the incident wave into the housing and exit of water of the preceding wave from the housing, which further facilitates acceleration of water flow through the turbine.

As a new wave causes water to flow through the housing, there are certain time moments when the respective pressures at the inlet and outlet are substantially equal. Normally, at these moments, the respective inlet valve (if present) and outlet valve are substantially closed. However, in some embodiments, the forward momentum of water being urged by the waves may keep the valve(s) open. During other moments the inlet experiences the wave-trough portion of an incident wave as the outlet experiences the wave-crest portion of the preceding wave. In this situation the inlet valve (if present) and outlet valve of the set tend to be substantially closed.

Removal of the turbine from the system allows the system to be used as a water pump useful for enhancing shoreline protection by subducting water from wave crests and filling in wave troughs.

The housing can have multiple sets of openings. Each set can comprise a respective inlet and a respective outlet. In other embodiments at least one set can have more inlets than outlets, or vice versa. In multiple-set embodiments, a respective one-way valve desirably is provided on each outlet and each inlet. Inlets are located in the housing upstream of the turbine, and outlets are located in the housing downstream of the turbine. In each set the respective inlet and outlet desirably are separated from each other by λ/2, wherein λ is the wavelength for which the set is most suitable. Desirably, the sets are axially displaced from each other. Among various benefits, having multiple sets of openings allows multiple waves to propagate through the housing at the same time, which can provide more continuous water flow through the housing and correspondingly more impetus to the turbine.

In certain embodiments comprising multiple sets of openings, wherein the respective inlets and outlets are separated from each other by λ/2, the actual value of λ/2 can be different for each set. Thus, as the system encounters waves of different wavelengths, water flow accompanying the waves enters and exits different openings. This use of different sets of openings by waves of different wavelength is facilitated by at least the outlets of the various sets having respective one-way valves. One or more of the inlets in these multiple-set embodiments also can have respective one-way valves. Each valve of each set opens and closes in response to local pressure conditions established by propagation of the respective wave, in a manner reminiscent of a flute. These embodiments can respond in a power-generating way to waves of various wavelengths, rather than only to waves of a particular wavelength.

Having multiple sets of openings allows different waves (including waves of different wavelengths) to propagate through the housing substantially at the same time. This situation can provide more water flow and more continuous water flow through the housing, which provides correspondingly more impetus to the turbine. Also, the multiple sets of openings allow the system to be used with a range of wavelengths that may be encountered by the system, whereas a system comprising a single housing with a single set of openings will be dormant if L=λ.

It is contemplated that multiple sets of openings may share an inlet or an outlet. For example, one embodiment may comprise a housing defining a single outlet located downstream of the turbine and two inlets located upstream of the turbine. In this embodiment the distance from the outlet to one inlet (“the” constituting one set of openings) can be λ₁/2, and the distance from the outlet to the other inlet (constituting can be λ₂/2, wherein λ₁≠λ₂. One or both inlets can include a respective one-way valve.

Although the openings in the drawings depict the openings as substantially round, this is not intended to be limiting. For example, it is contemplated that at least one opening can be configured as a slit opening, of which the axis of the slit (defined in the housing) is substantially parallel to the longitudinal axis of the housing. A single slit opening can allow the device to respond to a range of wavelengths.

### First Embodiment

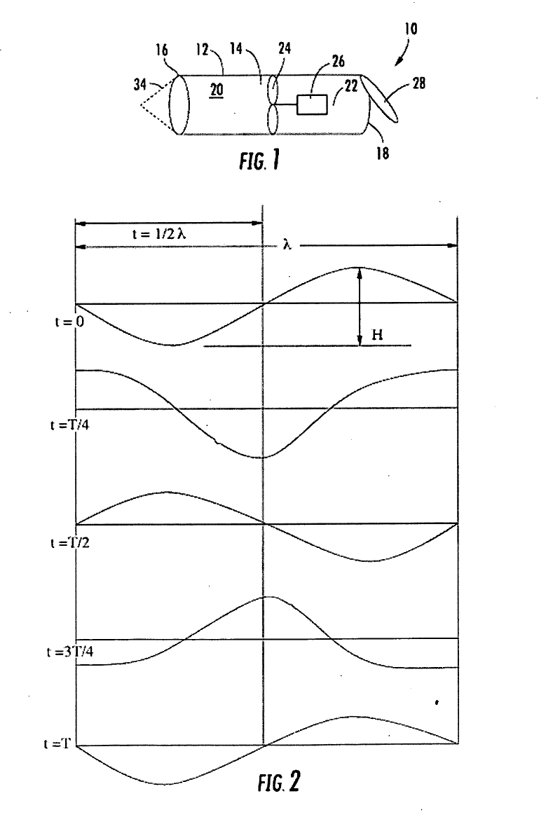

This embodiment is directed to a one-valve, half-wavelength device 10, as shown in FIG. 1. The device comprises a housing 12 defined by outer walls 14 (e.g., cylindrical walls, in the manner of a tube or pipe) and having an inlet 16 and an outlet 18. Thus, the housing 12 defines an interior space 20 that extends along an axis 22. In this embodiment, the length L of the interior space 20 along the axis 22 is substantially half the wavelength (λ/2) of waves to which the device 10 is responsive. The interior space 20 comprises a turbine 24 that is mounted and oriented relative to the axis 22 such that the turbine 24 rotates about the axis 22. The turbine 24 is coupled to a generator 26. Although the generator 26 is shown on the interior of the housing 12, the generator 26 is located exterior of the housing 12 in other implementations.

The inlet 16 is continuously open (no valve required), and a one-way outlet valve 28 (shown open) is situated on the outlet 18. Water entering the inlet 16 and propagating axially through the interior space 20 past the turbine 24 exits the housing 12 through the outlet valve 28 at the outlet 18. Thus, water (as urged by wave action) propagates through the housing 12 substantially in the propagation direction of the incident sea-waves.

As a result of its axially extended configuration, the housing 12 tends naturally to orient itself in water with the inlet 16 facing oncoming sea-waves. To such end a moor line (not shown) can be attached at or near the upstream end of the device 10 and used for anchoring the device to the sea floor or to a stationary object that is mounted to the sea floor. The housing 12 desirably is positioned just below the troughs of typical oncoming sea-waves, below low tide. The inlet end of the housing desirably comprises a debris screen 34 to prevent incursion of larger objects and organisms into the housing. In some implementations the screen 34 is omitted.

In this embodiment the inlet 16 and outlet 18 are located on respective ends of the housing 12, wherein the housing 12 has an axial length L≈λ/2, and λ is the wavelength of the sea-waves. A housing configured in this manner allows development in the housing of a differential pressure, from the inlet 16 to the outlet 18, sufficient for generating water flow through the turbine. The length λ/2 facilitates achieving this pressure difference. For comparison, if the housing 12 had a length L≈λ (or integer multiples thereof), then the device would be stagnant; i.e., differential pressure (from the inlet 16 to the outlet 18) necessary for flowing water through the turbine would not be produced inside the housing 12, and the device 10 would not respond in a power-generating way to the sea-waves encountered by the device.

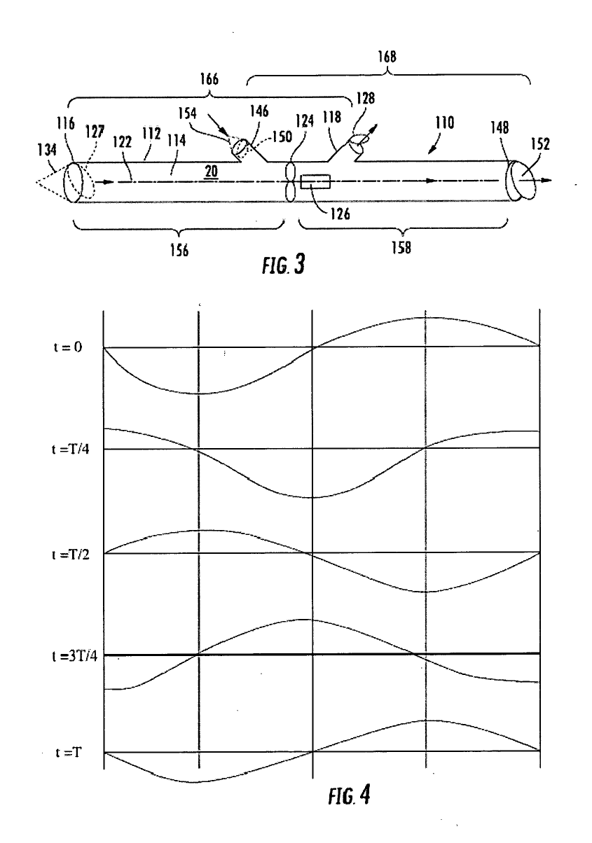

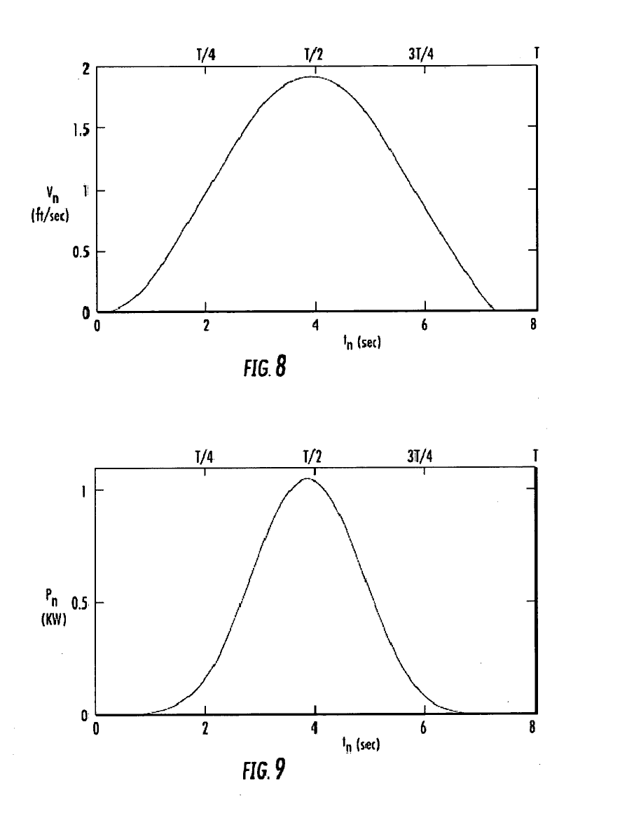

This concept is depicted in FIG. 2, in which the time t=0 can be regarded as the start of a wave-cycle. At t=0 the water inside the housing 12 is quiescent due to a previous negative pressure (from the previous wave) that depleted the water's momentum inside the housing. See t=0 region of FIG. 8, discussed later below. As the sea-wave advances relative to the device 10, the wave-crest (and hence the local pressure) becomes progressively more positive at the inlet 16 while the wave-trough (and hence the local pressure) becomes progressively more negative at the outlet 18. With a sinusoidal wave, the pressure drop along the axis from the inlet 16 to the outlet 18 increases with ΔH=H·sin(2πt/T), in which H is shown, and T is the period of the wave. Starting from zero at t=0, the pressure difference from the inlet 16 to the outlet 18 reaches a maximum positive pressure difference at t=T/4 in FIG. 2. This maximum positive pressure difference from the inlet 16 to the outlet 18 urges water inside the housing 12 to accelerate forwardly past the turbine 24. This forward water flow rotates the turbine and causes the generator 26 to produce power.

After t=T/4, the pressure difference from inlet to outlet begins to decrease and reaches zero at t=T/2, at which the pressure at the inlet 16 and the pressure at the outlet 18 become substantially equal. This reduction in the pressure difference initiates a reduction in the forward flow of water flow through the device. After t=T/2, the pressure difference between the inlet and outlet becomes negative. But, notwithstanding this negative pressure difference, forward water flow as urged by the wave continues through the device due to momentum of the long, heavy water column inside the housing. See t=T/2 region of FIG. 8. After t=T/2 and progressing to t=3T/4, the pressure at the inlet 16 approaches a maximum negative pressure while the pressure at the outlet 18 approaches a maximum positive pressure. These maxima are reached at t=3T/4, which is the moment of maximum negative pressure difference from the inlet 16 to the outlet 18. Notwithstanding this negative pressure difference, water continues to flow forwardly, but at a progressively reduced velocity (FIG. 8) that eventually reaches zero after t=3T/4, when the outlet valve 28 closes. The device remains substantially quiescent (no significant forward flow of water past the turbine) until after t=0 of the next wave, thus beginning the next wave-cycle. The calculated velocity-time profile is shown in FIG. 8

### Second Embodiment

The device 10 of the first embodiment is relatively simple, but the efficiency of the device 10 may not be sufficient for certain applications. More specifically, as noted above, the device 10 of the first embodiment experiences a quiescent period during each wave-cycle. In other words, periodic closing of the exit valve 28 of the device 10 prevents significant carry-over water momentum from one wave-cycle to the next. Also, in the first embodiment, the housing 12 has a defined axial length of λ/2 (from inlet to outlet). Devices according to the second embodiment address some of these issues.

An exemplary device 110 according to the second embodiment is depicted in FIG. 3. The device 110 comprises a housing 112 defined by outer walls 114, a first inlet 116, a first outlet 118, a second inlet 146, and a second outlet 148. The housing 112 defines an interior space 20 having a length, along the axis 122, of approximately λ. A turbine 124 is situated in the interior space at approximately mid-length. The turbine 124 is coupled to a generator 126. In other examples, the generator 126 is located outside of the housing 112.

The first inlet 116 comprises a screen 134 or the like to limit incursion of particulates into the interior space 120. Similarly, and for a similar reason, the second inlet 146 comprises a screen 154 or the like. In other examples, the screen 134 or screen 154 is omitted.

The first inlet 116 and first outlet 118 are separated by λ/2, and the second inlet 146 and second outlet 148 are separated by λ/2. The first inlet 116 and first outlet 118 constitute a first set of openings, and the second inlet 146 and second outlet 148 constitute a second set of openings. The first inlet 116 can have a one-way inlet valve 127, and the first outlet 118 includes a one-way outlet valve 128. The second inlet 146 can have a one-way inlet valve 150, and the second outlet 148 includes a respective one-way outlet valve 152.

The device 110 can be anchored to the sea floor by a moor line or the like connected at or near the first inlet 116. The portion of the housing 112 located upstream of the turbine 124 is termed the “upstream portion” or “inlet portion” 156, and the portion of the housing 112 located downstream of the turbine 124 is termed the “downstream portion” or “outlet portion” 158.

The device 110 is essentially two devices 10 (of the first embodiment) contained in a single housing 112. A first section 166 comprises the first set of openings (namely the first inlet 116 and first outlet 118). A second section 168 comprises the second set of openings (namely the second inlet 146 and second outlet 148). The first section 166 and second section 168 in this embodiment partially overlap each other in the region of the turbine 124.

With the device 110 a positive pressure nearly always exists at one or both the inlets 116, 146, while a negative pressure nearly always exists at one or both the outlets 118, 148. Thus, if both inlets and outlets are equipped with respective valves, the first inlet 116 and the first outlet 118 will be open or closed concurrently, and the second inlet 146 and second outlet 148 will be open or closed concurrently. These conditions assure that water flows through the turbine 124 substantially all the time during wave-cycles, instead of diminishing to zero by the end of each cycle as the device 10 of the first embodiment. Consequently, the device 110 can exhibit greater efficiency than the device 10 of the first embodiment.

As described above, the housing 112 provides an axial length of λ₁/2 from the first inlet 116 to the first outlet 118, and an axial length of λ₂/2 from the second outlet 146 to the second outlet 148. The description above was set forth with the assumption that λ₁=λ₂. However, the wavelengths of sea-waves are usually not equal all the time. Hence, an embodiment of which the housing has only one set of openings (such as the first embodiment) may exhibit reduced efficiency in actual sea conditions compared to an embodiment of which the housing has multiple sets of openings (such as the second and third embodiments). In the second embodiment, the wavelengths λ₁ and λ₂ that determine the spacings between respective openings can be the same or different.

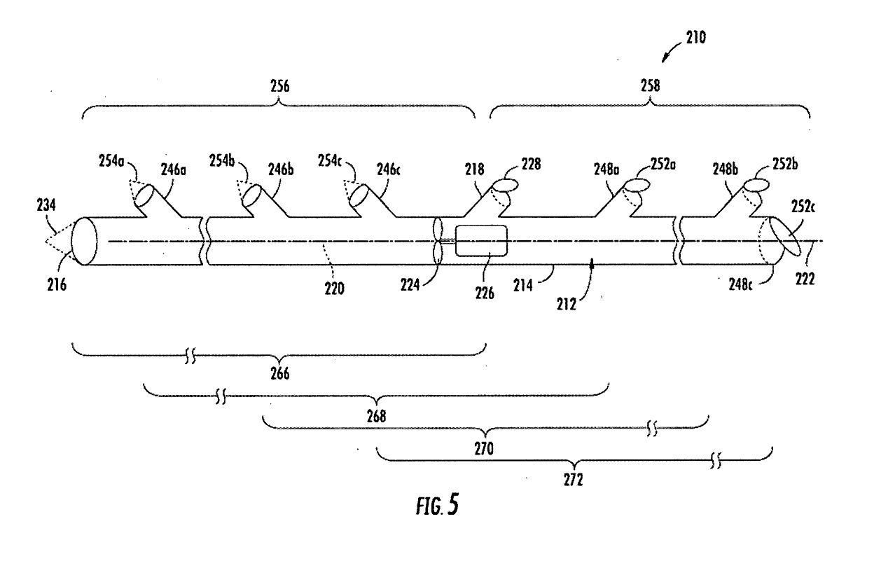

FIG. 4 provides pressure-profile plots at time instants t=0, t=T/4, t=T/2, t=3T/4, and t=T for a situation in which λ₁=λ₂. As water velocity (and its associated power) decline in one section due to passage of the wave through it, velocity and power increase in the other section. Since the two sections 166, 168 are effectively coupled together axially (with partial overlap) at the turbine 124, there is minimal adverse impact on the flow of water through the device 110. I.e., the respective water velocities in each portion 166, 168 can be added, considering that they are one-half cycle apart from each other. Since power is proportional to (velocity)³, the device 110 can produce more than twice the power produced by the device 10 of the first embodiment, all other factors being equal.

It will be understood that the device 110 of this embodiment can be generalized to any multi-set system usable with multiple wavelengths; an example is discussed below in the third embodiment.

### Third Embodiment

As noted, seas, oceans, and other bodies of water usually produce waves of varying wavelength. Hence, the relative dimensions (in terms of λ or λ₁ and λ₂) of the spacing of openings in the housing 112 of the second embodiment are approximate and suitable for particular, but nevertheless limited, conditions. A device 210 according to the third embodiment comprises an axially extended housing 212 with a turbine situated between the two ends of the housing (e.g., at approximately mid-length inside the housing). However, the length of the housing 212 is not limited to λ or a particular value thereof, but rather is longer than λ of a particular wave. The device 210 can be anchored to the sea floor by a moor line or the like (not shown) connected at or near the inlet 216.

The device 210 is depicted generally in FIG. 5. The depicted device 210 according to this embodiment comprises a housing 212 defined by outer walls 214. The housing 212 defines an interior space 220 that extends along an axis 222. A turbine 224, coupled to a generator 226, is situated in the interior space 220. In other implementations the generator 226 is exterior of the housing 212.

The housing 212 defines a first set of openings including an inlet 216 and an outlet 218. The inlet 216 is on the upstream end of the housing 212. The housing 212 also defines additional sets of openings including a second set (consisting of an inlet 246a and an outlet 248a), a third set (consisting of an inlet 246b and an outlet 248), and a fourth set (consisting of an inlet 246c and an outlet 248c, wherein the outlet 248c is located on the downstream end of the housing 212). If desired or required, the housing 212 can define further sets (not shown). Each inlet 216, 246a, 246b, 246c includes a respective screen 234, 254a, 254b, 254c or the like for use as described in the second embodiment. In other embodiments, one or more of the screens are omitted. If desired or required, one or more of the inlets 216, 246a, 246b, 246c can have a respective one-way valve (not shown). Each of the outlets 218, 248a, 248b, 248c includes a respective one-way valve 228, 252a, 252b, 252c.

Although four sets of openings are detailed in FIG. 5, it will be understood that this number is not limiting, and the device 210 can have more than or fewer than four sets. A two-set embodiment, in which λ₁≠λ₂, is similar to the second embodiment. The portion of the housing 212 located upstream of the turbine 224 is termed the “inlet portion” 256, and the portion of the housing 212 located downstream of the turbine 224 is termed the “outlet portion” 258. FIG. 5 depicts a first section 266, a second section 268, a third section 270, and a fourth section 272. The first section 266 comprises the first set of openings 216, 218 and the intervening portion of the housing; the second section 268 comprises the second set of openings 246a, 248a and the intervening portion of the housing; the third section 270 comprises the third set of openings 246b, 248b and the intervening portion of the housing; and the fourth section 272 comprises the fourth set of openings 246c, 248c and the intervening portion of the housing. The sections 266, 268, 270, 272 partially overlap each other at the turbine 224.

As a result of the multiple sections 266, 268, 270, 272 the inlet portion 256 has a length substantially greater than λ/2 of any particular wave to which the device 210 is responsive. With this configuration the inlet portion 256 and outlet portion 258 can each be quite long to accommodate the respective openings. As wave energy progresses down the system, the inlets and outlets selectively open and close in a manner reminiscent of a flute.

Parametric aspects of the various embodiments (e.g., turbine type and size, specifications of the generator, housing lengths and diameters, spacings and diameters of inlets and outlets, specifics of construction, and manner of mooring) can be selected based on the particular wave environment to which the device will be normally subjected. For example, off the Oregon coast, wave heights average 3.5 m during winter and 1.3 m in summer. The wave periods in this location range generally from 7 to 13 seconds. These variables, in turn, are used to determine spacings of respective inlets and outlets of the various sets of openings defined by the housing. It is also contemplated that inlets and outlets are not limited to being spaced apart by respective values of λ/2; other spacings could be used, such as, but not limited to, λ/4. It is also contemplated that the usual turbulence of the sea would indicate that the housing be flexible or articulated to have sufficient compliance to withstand expected conditions of currents, waves, wind, and weather. Segmented or articulated housings also would likely be easier to assemble, especially in situ. It is also contemplated that multiple housings can be connected together in a manner by which several housings in parallel can contribute flow to a single turbine, both on the intake and the exhaust sides.

Anticipated are “sheets” of multiple devices extending over segments of a coast. Since the devices are placed just below the water surface, visual impact would be little to none. However, navigational precautions may be necessary, especially in view of sea traffic both on the surface and beneath the waves. Also anticipated are “sheets” of multiple inlet sections leading to and driving a single turbine and generator to increase water velocity past the turbine and hence boost system efficiency. In such a sheet, multiple inlet sections may converge to a single housing containing the turbine and generator, then diverge into multiple outlet sections. Although wide deployment of sea-wave energy-conversion systems has the potential to make a major positive impact on electric utility systems, an auxiliary benefit is coastline protection, as power is extracted from waves.

If the turbine is removed the system becomes a water pump, enhancing shoreline protection by subducting water from crests and filling in troughs. The water moved would be greater than for the case with the turbine due to reduced resistance.

Turbine Considerations

Although the pressure head powering the turbine normally is transient, the turbine can be considered a quasi-steady device for sea-wave frequencies. Shaw, Wave Energy˜A Design Challenge, Ellis Harwood Pub., 1982. A quasi-steady estimate assumes the turbine operates instantaneously at the then-pertaining head for each considered small time step, as though it were encountering a steady-state pressure head identical to the instantaneous pressure head. The average power produced during a cycle is estimated by summing the energy produced during all of the (small) time steps (dt) during one wave period, and then dividing by the period itself. Low-head Kaplan turbines, similar to those used in tidal-power systems operating in a pressure-head range of 2-8 meters, will be appropriate for the instant embodiments. Turbine technology is well-known, and will not be further considered here.

Water flowing through the housing and turbine will experience a pressure-head loss defined by:

H=[1+f(L/D)+ΣCᵢ+Kₜ]V²/2g=KV²/2g (1)

in which f is the friction factor, L is the length of the housing, D is the diameter of the housing, and g is acceleration due to gravity. The Cᵢ term represents “minor” losses other than friction, due to valves, intake-debris screens, bends, etc. Kₜ represents the resistance to flow through the turbine, and V is the average velocity in the housing.

Even low water velocities inside a large (e.g., 2-3 m diameter) housing will still manifest highly turbulent flow. A friction factor f=0.021 is considered below, and reference to a Moody Diagram (see, e.g., Cengel and Turner, Fundamentals of Thermal-Fluid Sciences, 2d Ed., McGraw-Hill, 2005) suggests that f will be constant at high Reynolds numbers. This is a conservative value for the Reynolds numbers characteristic of the applications discussed herein.

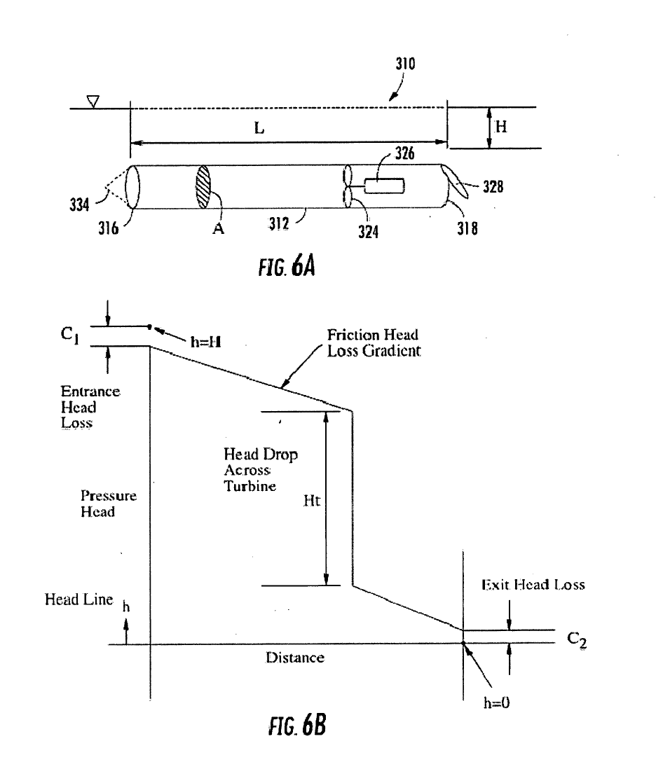

FIG. 6(A) depicts a representative system 310 comprising a turbine 324 inside a housing 312. The housing 312 includes an inlet 316 and an outlet 318. The outlet 318 includes a one-way valve 328. The inlet 316 includes a screen 334. The housing 312 has a transverse sectional area A and a length L. For a constant pressure-head (H) across the system, the pressure head versus length (distance) is indicated in FIG. 6(B). The total pressure-head H comprises the pipe-resistance head [1+f(L/D)+ΣCᵢ] V²/2 g=K_{P}V²/2 g, and the resistance loss through the turbine, KₜV²/2g. Thus, H=Hₜ+Hₚ, which is Equation (1). For a quasi-steady state of flow, the power extracted from the turbine and generator is P=ηρgAVHₜ=ηρgAV(H−Hₚ), wherein η is a turbine efficiency factor. For quasi-steady state conditions, V=[2gHp/Kₚ]^{0.5}. Hence,

P=ηρgA(2g/Kₚ)(H*Hₚ^{0.5}−Hₚ^{1.5}) (2)

Optimizing the turbine, such that power P for a given pressure head is maximized by taking dP/dHₚ=0, leads to:

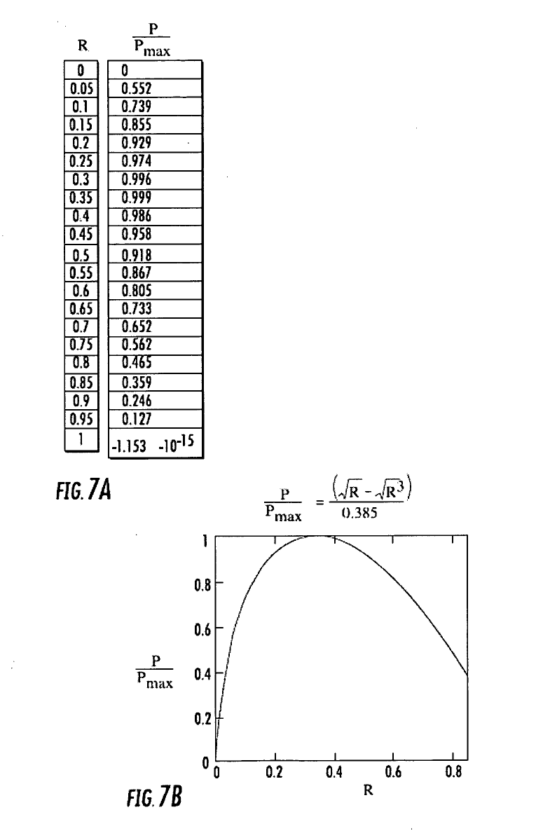

Hₚ*=H/3 and Hₜ*=2H/3 (3)

wherein the asterisk denotes an optimized condition. Equation (3) indicates that maximum power is obtained when the flow resistance through the turbine is double the friction and minor loss resistance offered by the housing. FIGS. 7(A)-7(B) present data and a curve, respectively, of the ratio of power to maximum power (P/Pₘₐₓ) versus R=Hₚ/H. As predicted by Equation (3), the maximum occurs at R=⅓, but the curve is somewhat flat near the maximum. The table of FIG. 7(A) also shows that 90% of the maximum power occurs in a range 0.18<R<0.51. This curve indicates that power production from a continually varying quasi-steady state turbine is somewhat insensitive to changing conditions. Equation (3) also leads to a simple condition for maximum power based on loss coefficients, namely:

Kₜ=2Kₚ (3′)

In a steady-state operation with a constant pressure head H, power production from water flowing through a turbine is given by P=ηρAVHₜ. In a dam or tidal power system, Hₜ remains positive and nearly constant over a considered period. In the instant embodiments, due to the momentum of a column of water, the pressure head could actually become negative while the water is still flowing. Hence, a virtual pressure head is calculated for Hₜ that would cause such water flow. For the quasi-steady flow, the virtual pressure head required to cause flow through the turbine with a given average velocity V is Hₜ=KₜV²/2g. Thus,

P=ηρAKₜV³/2 (4)

is used to estimate the power produced by water flowing through the turbine. The energy produced during a small time increment (dt) is Eᵢ=Pᵢdt.

Analysis of First Embodiment

As described above (see FIG. 1), the first embodiment comprises a single tube-like housing 12 containing a turbine 24 coupled to a generator 26. The housing 12 has a single inlet 16 and a single outlet 18 (the latter having a one-way valve 28). The outlet valve 28 allows water to flow through the device generally in the direction of waves propagating in the surrounding water. Hence, this embodiment is configured in the manner of a hydraulic “diode” that is oriented perpendicularly to an oncoming wave-front of water. The device 10 is positioned in the water below the troughs of typical waves. The length L of the housing 12 is λ/2, as described. If the housing length L were L=λ, then a differential pressure head would not be produced by a wave having a wavelength λ, the turbine 24 would exhibit little to no motion, and the generator 26 would not generate any significant amount of power. Even with a housing having length L=λ/2, at t=0 the water inside the housing 12 is quiescent and no pressure-head differential is present from the inlet 16 to the outlet 18. As the sinusoidal sea-wave advances, the wave crest increases (becoming more positive) on the inlet side as the wave trough “increases” (becoming more negative) on the outlet side. Thus, the pressure drop across the housing 12 from inlet 16 to outlet 18 increases as ΔH=H·sin(2πt/T). Starting from zero at t=0, the pressure difference from inlet to outlet increases and reaches a maximum at t=T/4 (see FIG. 2). This pressure difference causes water inside the housing 12 to accelerate through the turbine 24, thereby accelerating the angular velocity of the turbine, and causing the generator 26 to produce power.

Ignoring the pressure gradient across the diameter of the housing 12, and using the pressure at the center of the housing, the equation of motion for the incompressible water column can be written as follows (using the form F=ma):

ρgHA sin(2πt/T)−½AKρV²=ρAL(dV)/dt (5)

The first term in Equation (5) is associated with the force on the water column inside the housing 12 due to wave-height difference. The second term relates to flow losses due to outlet pressure, friction losses inside the housing, “minor” losses, and the resistance manifested by flow through the turbine 24 itself. The right-hand term is the acceleration term. Thus, a non-linear ordinary differential equation is provided that describes water velocity inside the housing 12 during a wave-cycle:

dV/dt+(K/2L)V²=(gH/L) sin(2πt/T) with I.C. V(0)=0 (6)

Note that, in the above equations, the pipe diameter (D) (i.e., housing diameter) does not directly appear, except obliquely in K.

### Example 1

This example is directed to the first embodiment, wherein the non-linear differential Equation (6) is solved numerically for typical conditions of a repetitive sinusoidal summer sea-wave in the ocean off the west coast of the United States. The power per unit wave-front in a deep-water wave is P=(0.55)H²T, in units of kW/m. Shaw, id.; Sorenson, Basic Wave Mechanics for Coastal and Ocean Engineers, John Wiley & Sons, N.Y., 1993. Based on such conditions, system characteristics were established as follows:

| Ocean Wave Characteristics: | System Characteristics: |
|---|---|
| H = 1.22 m = 4 ft | D = 1.83 m = 6 ft |
| λ = 100 m = 328 ft | L = 50 m = 164 ft |
| T = 8 seconds | Kₜ = 4 f = 0.021 Cᵢ = 0.30 |
| Power in Wave = 6.54 kW/m | η= 0.8 |

A system having these characteristics is schematically depicted in FIG. 1. For these conditions K=5.873. FIG. 8 shows the solution to Equation (6), for these characteristics, as a plot of velocity (Vₙ) as a function of time (tₙ). Note that the momentum of the water built up during the first half-cycle (t<T/2=4 sec) continues to force the water axially through the housing and past the turbine, even against an increasing negative pressure head during the second half-cycle, up to 7.2 sec. Then the outlet valve 28 closes and the water velocity through the housing 12 is zero, until the next advancing wave causes the cycle to repeat. In FIG. 8 the maximum velocity (Vₙ) achieved is 1.90 ft/sec (0.58 m/sec).

As water passes through the housing 12 and flows past the turbine 24, power is generated in accordance with Equation (4). The curve of instantaneous power (Pₙ) as a function of time (tₙ) is presented in FIG. 9. The maximum instantaneous power produced is 1.05 kW. But, when the power curve is integrated over the period of T=8 seconds, the average power produced is P=0.271 kW. The integrated system efficiency for the period is:

SysEff=Power/[(Power in Wave)*D] (7)

For the considered conditions and this example system, SysEff=0.023=2.3%.

If the calculation is performed again with a wave period T=10 seconds and H=2.13 m=7 ft wave, then the wavelength increases to 156 m (512 ft). Under such conditions, the housing length desirably is L=78 m (256 ft). The power in this larger wave is 25.05 kW/m, the power produced is P=0.723 kW, and SysEff=0.016=1.6%. The diminished efficiency of the longer system is due to the longer column of water that must be accelerated from quiescence.

### Example 2

This example is an investigation of the second embodiment. Whereas the first embodiment is relatively simple, it tends to exhibit lower efficiency than the second embodiment. FIG. 8 shows that, in every cycle, the system starts from a quiescent-water state. Thus, the water inside the housing passing through the turbine does not develop significant carry-over momentum from one cycle to the next. For the cycle considered in the previous example, the maximum water velocity in a housing having L=50 m (164 ft) was V=0.58 m/sec (1.90 ft/sec). The kinetic energy of the water column in a housing having a diameter D=1.83 m (6 ft) was 22.57 kW-sec. Nearly all of that energy is dissipated in the second half of the cycle by the increasing negative head of the traveling wave. Also, in the first embodiment, the optimum housing length is half the wavelength of the sea-wave. But, since the wavelength varies with the period of the wave, the wavelength is continually changing. Hence, a device according to the first embodiment will be less advantageous than the second embodiment for prevailing conditions.

Reference is made again to FIG. 3 for a schematic diagram of this example. The inlet portion 156 will nearly always have a positive pressure head at one or more of the inlets 116, 146, and the outlet portion 158 (downstream of the turbine 124) will nearly always have a negative pressure head at or more of the outlets 118, 148 (except at one neutral instant). Hence, in this embodiment, there is nearly always flow through the turbine 124, yielding a correspondingly greater efficiency than the first embodiment.

In this example, the length of the housing 112 was equal to the wavelength λ of a subject wave, and the first section 166 and second section 168 were each λ/2 in length. The two inlets 116, 146 were separated from each other by approximately λ/2, as were the two outlets 118, 148. As noted, this configuration is similar to two of the first-embodiment systems 10 connected together such that, as water-velocity and power decline in one section 166 or 168, they increase in the other section 168 or 166 (compare FIGS. 8 and 9). Since the two sections 166, 168 overlap at the turbine 124, and such coupling has minimal impact on water flow-rates, the water velocities exhibited by each section (indicated in FIG. 8) can be added, considering that they are one-half cycle apart from each other.

The power is proportional to the cube of velocity (Equation (4)), so the system 110 can produce more than twice the output power of the system 10 of the first embodiment. For example, if H=1.12 m and T=8 sec, the velocity through the turbine 124 is nearly constant throughout each wave-cycle, varying between 0.58 m/sec (1.90 fps) and 0.54 m/sec (1.76 fps). The power output is nearly constant throughout the wave-cycle and averages 0.94 kW. The power-conversion efficiency is (0.94/11.97)=7.9%.

In this study the depth at which the housing 110 is moored and the actual diameter of the housing 110 are regarded as comparable. This situation generates a significant pressure difference across the vertical diameter of the housing, which generates a non-parabolic, and hence rather complicated, velocity profile of water-flow in the axial direction through the housing. The evaluation performed above did not take into account the complex velocity profile.

Although the housings described above are shown having a cylindrical shape, this is not intended to be limiting. Other axially extended shapes are possible.

Although the embodiments described above each are shown having a single turbine, it will be understood that multiple-turbine configurations alternatively can be used.

Although each inlet and outlet in the embodiments described above is shown as a single entity at a respective location on the housing, it will be understood that multiple openings can be situated at a given location on the housing. For example, a given inlet can be configured as multiple openings such as one on an upper surface of the housing and another on a lower surface of the housing.

List of Symbols

A Flow area of housing (m²)

Cᵢ Minor flow loss in housing other than friction

D Diameter of housing (m)

f Pipe friction factor (here, a constant, f=0.021)

H Wave height from crest to trough (m)

H Total pressure head in system (m)

Hₚ Pressure drop across housing (m)

Hₜ Pressure drop across turbine (m)

K Flow-loss coefficient

Kₜ Resistance coefficient through the turbine

L Length of the housing (m)

Q Volumetric water flowrate=A*V (m³/sec)

t Time (sec)

T Wave period (sec)

V Velocity of water inside housing (m/sec)

η Turbine efficiency

λ Length of sea-wave (m)

ρ Density of sea water (kg/m³)

Whereas the invention has been described above in connection with multiple representative embodiments, it will be understood that it is not limited to those embodiments. On the contrary, the invention is intended to encompass all modifications, alternatives, and equivalents as may be included within the spirit and scope of the invention, as defined by the appended claims.

What is claimed is:

1. A device for converting sea-wave energy into electrical energy, comprising:
a submersible housing defining at least a first set of openings, the first set comprising an inlet situated on an upstream portion of the housing and an outlet situated on a downstream portion of the housing, the housing when submersed in water being orientable toward a sea-wave propagating in the water such that the sea-wave is incident on the inlet and a portion of the sea-wave can enter the inlet;
an outlet valve located at the outlet, the outlet valve being configured as a one-way check valve to pass water flow from inside the housing through the outlet to outside the housing;
an electrical generator; and
a turbine situated in the housing between the inlet and the outlet and coupled to the generator such that flow of water, urged by the sea-wave, through the inlet, past the turbine, and through the outlet rotates the turbine.

2. The device of claim 1, wherein the outlet valve is configured to open in response to local pressure inside the housing being greater than local pressure outside the housing and to close in response to local pressure outside the housing being greater than local pressure inside the housing.

3. The device of claim 1, further comprising an inlet valve located at the inlet, the inlet valve being configured as a one-way check valve to pass water flow, as urged by the sea-wave, from outside the housing through the inlet to inside the housing.

4. The device of claim 1, wherein the inlet admits water flow associated with a wave-crest portion of an incident sea-wave into the housing as the outlet allows egress of water flow associated with a wave-trough portion of a preceding sea-wave encountered by the device.

5. The device of claim 1, wherein:
the sea-wave has a wavelength λ; and
the housing includes a region having an axial length of λ/2 between the inlet and the outlet.

6. The device of claim 5, wherein:
the housing comprises an upstream end and a downstream end;
the inlet is located on the upstream end; and
the outlet is located on the downstream end.

7. The device of claim 1, wherein:
the housing defines at least a second set of openings, the second set comprising a respective inlet situated on the upstream portion of the housing and a respective outlet situated on the downstream portion of the housing; and
the outlet of the second set comprises a respective outlet valve configured as a one-way check valve to pass water flow from inside the housing through the outlet of the second set to outside the housing.

8. The device of claim 7, wherein the outlet valve of the second set opens in response to local pressure inside the housing being greater than local pressure outside the housing.

9. The device of claim 7, wherein the inlet of the second set comprises an inlet valve configured as a one-way check valve to pass water flow, as urged by the sea-wave, from outside the housing through the inlet of the second set to inside the housing.

10. The device of claim 7, wherein:
the sea-wave has a wavelength λ;
the housing includes a first region having an axial length of λ/2 between the inlet and the outlet of the first set; and
the housing includes a second region having an axial length of λ/2 between the inlet and the outlet of the second set.

11. The device of claim 10, wherein the first and second regions are axially displaced from each other.

12. The device of claim 7, wherein:
a first sea-wave has a wavelength λ;
a second sea-wave has a wavelength λ₂;
the housing includes a first region having an axial length of λ₁/2 between the inlet and the outlet of the first set; and
the housing includes a second region having an axial length of λ₂/2 between the inlet and the outlet of the second set.

13. The device of claim 12, wherein the first and second regions are axially displaced from each other.

14. The device of claim 12, wherein λ₁=λ₂.

15. The device of claim 12, wherein λ₁≠λ₂.

16. The device of claim 12, wherein the inlet of the second set admits water flow associated with a wave-crest portion of an incident second sea-wave into the housing as the outlet of the second set allows egress of water flow associated with a wave-trough portion of a preceding second sea-wave encountered by the device.

17. The device of claim 7, wherein a pressure differential in the housing established by the second set of openings is at a different instant in time than a pressure differential in the housing established by the first set of openings.

18. The device of claim 1, further comprising a second inlet situated on the upstream portion of the housing.

19. The device of claim 1, further comprising a second outlet situated on the downstream portion of the housing.

20. A method for producing electrical energy from sea-wave energy, comprising:
submerging a housing in water in which sea-waves are propagating, the housing having an upstream portion and a downstream portion;
defining at least a first set of openings in the housing, the first set including an inlet on the upstream portion of the housing and a outlet on the downstream portion of the housing;
orienting the housing toward a propagating wave in the water such that the wave is first incident on the inlet;
opening the outlet in response to local pressure inside the housing being greater than local pressure outside the housing so as to allow water flow associated with at least a portion of the incident wave to enter the inlet and establish a pressure differential in the housing, the pressure differential causing a water flow from the inlet, through the housing, and through the outlet;
passing the water flow through a turbine to actuate the turbine; and
driving an electrical generator with the actuated turbine.
